(19) United States
(12) Patent Application Publication
(10) Pub. No.: US 2026/0125596 A1
(43) Pub. Date: May 7, 2026

(54) CURABLE COMPOSITION, CURED LAYER USING THE COMPOSITION AND DISPLAY DEVICE INCLUDING THE CURED LAYER

(71) Applicant: SAMSUNG SDI CO., LTD., Yongin-si, Gyeonggi-do (KR)

(72) Inventors: Sehee PARK, Suwon-si (KR); Jiyoung JEONG, Suwon-si (KR); Woo Jung SHIN, Suwon-si (KR); Seongmi JEON, Suwon-si (KR); Jinwon PARK, Suwon-si (KR); Young Woong JANG, Suwon-si (KR); Bumjin LEE, Suwon-si (KR)

(21) Appl. No.: 19/117,370

(22) PCT Filed: Apr. 2, 2024
(86) PCT No.: PCT/KR2024/004210

§ 371 Date: Mar. 31, 2025

(30) Foreign Application Priority Data
Aug. 29, 2023 (KR) 10-2023-0113812

(51) Int. Cl. C09K 11/88; C09K 11/02; C09K 11/62

(52) U.S. Cl. CPC C09K 11/88; C09K 11/025; C09K 11/62; C09K 11/883

(57) ABSTRACT

Disclosed are a curable composition, a cured layer using the same, and a display device including the cured layer. The curable composition includes (A) quantum dots including a first functional group represented by Chemical Formula 1 and a second functional group including a *—OC(═O) group at the terminal end, and (B) a polymerizable compound.

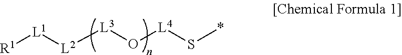

(In Chemical Formula 1, each substituent is as defined in the specification.)

### TECHNICAL FIELD

This disclosure relates to a curable composition, a cured layer using the composition, and a display device including the cured layer.

### BACKGROUND ART

In the case of general quantum dots, due to surface characteristics having hydrophobicity, a solvent in which it is dispersed is limited, and thus, it is difficult to introduce into a polar system such as a binder or a curable monomer.

A quantum dot photoresist composition applied to a quantum dot display, like a conventional photoresist composition, consists of photosensitive monomers, binders, initiators, solvents, additives, and the like and also, includes quantum dots and light diffusing agents instead of pigments/dyes for securing color characteristics, wherein the quantum dots have a function of converting incident blue light into red and green light after forming a single film.

As the quantum dots represented by CdSe, InP, etc. are rapidly progressing in terms of luminous efficiency (a quantum yield), a synthesis method thereof capable of achieving the luminous efficiency close to 100% is currently being introduced. Currently, QD-OLED TV using a quantum dot ink composition based on OLED blue backlight has been successfully commercialized. As a later version, a quantum dot display made by using Blue μ-LED as backlight is being developed. Since this μ-LED light source has very stronger intensity than conventional OLEDs, it is one of key technologies to develop a quantum dot photoresist composition capable of withstanding the strong light intensity of the μ-LED light source.

### DISCLOSURE

### Technical Problem

An embodiment provides a quantum dot-containing curable composition that secures light resistance reliability, which is the ability to withstand strong light.

Another embodiment provides a cured layer produced using the curable composition.

Another embodiment provides a display device including the cured layer.

### Technical Solution

An embodiment provides a curable composition including (A) quantum dots including a first functional group represented by Chemical Formula 1 and a second functional group including a *—OC(═O) group at the terminal end, and (B) a polymerizable compound.

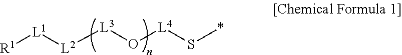

In Chemical Formula 1,
R¹ is a substituted or unsubstituted C1 to C20 alkyl group, a substituted or unsubstituted C3 to C20 cycloalkyl group, a substituted or unsubstituted C3 to C20 cycloalkenyl group, a substituted or unsubstituted C2 to C20 heterocycloalkyl group, a substituted or unsubstituted C6 to C20 aryl group, or a fused ring group thereof,
L¹ to L⁴ are each independently a single bond, an ether group (*—O—*), or a substituted or unsubstituted C1 to C20 alkylene group, and
n is an integer from 1 to 20.

The second functional group may be represented by Chemical Formula 2.

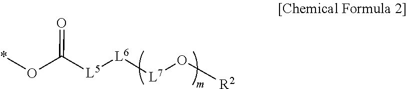

In Chemical Formula 2,
R² is a substituted or unsubstituted C1 to C20 alkyl group, a substituted or unsubstituted C3 to C20 cycloalkyl group, a substituted or unsubstituted C2 to C20 heterocycloalkyl group, a substituted or unsubstituted C6 to C20 aryl group, or *—C(═O)R³, wherein R³ is a C1 to C10 alkyl group or

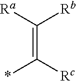

(wherein R^{a} to R^{c} are each independently a hydrogen atom or a C1 to C10 alkyl group),
L⁵ to L⁷ are each independently a single bond, an ether group (*—O—*), an ester group (*—C(═O)O—* or *—OC(═O)—*), or a substituted or unsubstituted C1 to C20 alkylene group, and
m is an integer of 1 to 20.

The first functional group and the second functional group may be included in a molar ratio of 1:0.5 to 1:1.5.

The first functional group may be represented by at least one selected from Chemical Formula 1-1 to Chemical Formula 1-3.

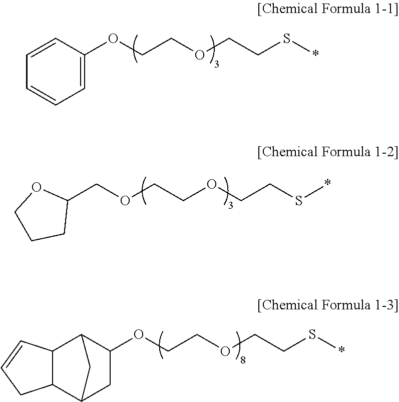

The second functional group may be represented by at least one selected from Chemical Formula 2-1 to Chemical Formula 2-4.

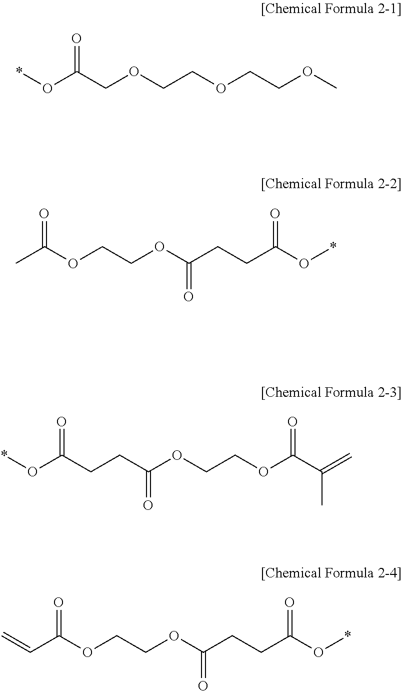

The first functional group may be derived from a compound represented by Chemical Formula 3.

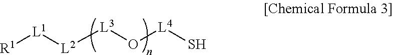

In Chemical Formula 3,
R¹ is a substituted or unsubstituted C1 to C20 alkyl group, a substituted or unsubstituted C3 to C20 cycloalkyl group, a substituted or unsubstituted C3 to C20 cycloalkenyl group, a substituted or unsubstituted C2 to C20 heterocycloalkyl group, a substituted or unsubstituted C6 to C20 aryl group, or a fused ring group thereof,
L¹ to L⁴ are each independently a single bond, an ether group (*—O—*), or a substituted or unsubstituted C1 to C20 alkylene group, and
n is an integer from 1 to 20.

The compound represented by Chemical Formula 3 may be represented by at least one selected from Chemical Formula 3-1 to Chemical Formula 3-3.

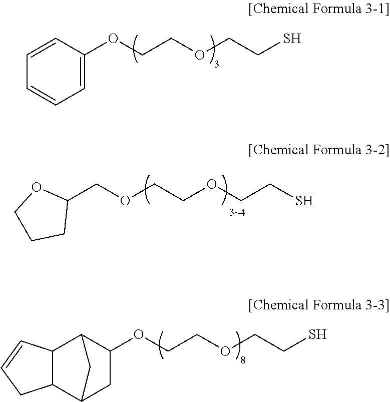

The second functional group may be derived from a compound represented by Chemical Formula 4.

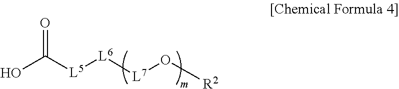

In Chemical Formula 4,
R² is a substituted or unsubstituted C1 to C20 alkyl group, a substituted or unsubstituted C3 to C20 cycloalkyl group, a substituted or unsubstituted C2 to C20 heterocycloalkyl group, a substituted or unsubstituted C6 to C20 aryl group, or *—C(═O)R³, wherein R³ is a C1 to C10 alkyl group or

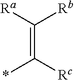

(wherein R^{a} to R^{c} are each independently a hydrogen atom or a C1 to C10 alkyl group),
L⁵ to L⁷ are each independently a single bond, an ether group (*—O—*), an ester group (*—C(═O)O—* or *—OC(═O)—*), or a substituted or unsubstituted C1 to C20 alkylene group, and
m is an integer of 1 to 20.

The compound represented by Chemical Formula 4 may be represented by at least one selected from Chemical Formula 4-1 to Chemical Formula 4-4.

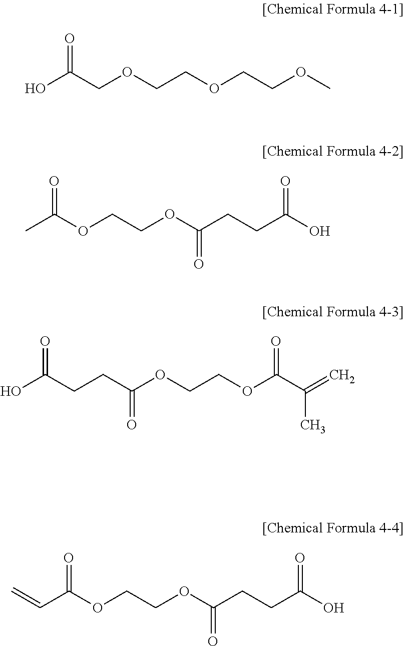

The curable composition may further include a polymerization initiator, a binder resin, a light diffusing agent, a solvent, or a combination thereof.

The light diffusing agent may include barium sulfate, calcium carbonate, titanium dioxide, zirconia, or a combination thereof.

The curable composition may further include malonic acid; 3-amino-1,2-propanediol; a polymerization inhibitor; a silane-based coupling agent; a leveling agent; a fluorine-based surfactant; or a combination thereof.

The curable composition may include 1 wt % to 40 wt % of the quantum dots; 1 wt % to 20 wt % of the polymerizable compound; 0.1 wt % to 5 wt % of the polymerization initiator; 1 wt % to 30 wt % of the binder resin; 1 wt % to 20 wt % of the light diffusing agent; and 40 wt % to 80 wt % of the solvent based on a total weight of the curable composition.

Another embodiment provides a cured layer manufactured using the curable composition.

Another embodiment provides a display device including the cured layer.

Other embodiments of the present invention are included in the following detailed description.

### Advantageous Effects

By surface-modifying the quantum dots in a curable composition including quantum dots with a quantum dot surface-modifying material having a composition that has not been previously available, the light resistance reliability of the curable composition can be improved.

### BEST MODE

Hereinafter, embodiments of the present invention are described in detail. However, these embodiments are exemplary, the present invention is not limited thereto and the present invention is defined by the scope of claims.

As used herein, when specific definition is not otherwise provided, “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when specific definition is not otherwise provided, “substituted” refers to replacement of at least one hydrogen atom by a substituent selected from a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when specific definition is not otherwise provided, “hetero” refers to inclusion of at least one heteroatom of N, O, S, and P, in the chemical formula.

As used herein, when specific definition is not otherwise provided, “(meth)acrylate” refers to both “acrylate” and “methacrylate,” and “(meth)acrylic acid” refers to “acrylic acid” and “methacrylic acid.”

As used herein, when specific definition is not otherwise provided, the term “combination” refers to mixing or copolymerization.

In the present specification, when a definition is not otherwise provided, hydrogen is bonded at the position when a chemical bond is not drawn in chemical formula where supposed to be given.

In addition, in the present specification, when a definition is not otherwise provided, “*” refers to a linking point with the same or different atom or chemical formula.

Light resistance reliability in this specification refers to light resistance reliability under high light resistance conditions (left for more than 500 hours in a backlight of 100,000 nit or more).

A quantum dot-containing curable composition according to the present invention may use a surface-modifying material with a novel composition to surface-modify the quantum dot, achieving high light resistance reliability, compared with a conventional quantum dot-containing curable composition.

According to the recent trend in the display field where a light source is being replaced from OLED to micro LED, light resistance of a film mounted inside the display becomes more important than ever. Accordingly, light resistance of a cured layer formed by curing the quantum dot-containing curable composition also becomes very important to improve, but a conventional quantum dot surface-modifying material alone fails in securing excellent film light resistance not enough to be used for the micro LED light source.

In general, in order to improve a curing rate of the quantum dot-containing curable composition, a high-sensitivity initiator or a multi-functional monomer, etc. are additionally used, and the above conventional arts, which select a specific configuration, may improve one characteristic among all characteristics of the quantum dot-containing curable composition such as dispersion, heat resistance, and the curing rate but deteriorates the other characteristics excluding the improved characteristic. In other words, regarding the characteristics of the quantum dot-containing curable composition, there has been no known technology for a quantum dot-containing curable composition capable of maintaining low viscosity and realizing high light resistance.

Specifically, the technology known so far includes a method of encapsulating the surfaces of the quantum dots with a polymer including a heat-resistant functional group or a siloxane (or TEOS, etc.)-based organic material, etc. or encapsulating the surfaces of the quantum dots with aluminum, titanium, or an oxide thereof. In addition, attempts have recently been made to simultaneously increase luminance and durability by doping a small amount of a transition metal (Cu, Mg, etc.) component in the quantum dot synthesis.

However, the above methods are still under academic study and far away to apply to actually apply to a display.

Accordingly, the inventors of the present invention have repeatedly conducted research and have come to complete a curable composition with excellent light resistance reliability even under high light resistance conditions by performing surface modification of quantum dots using two different types of surface-modifying materials. For example, a curable composition according to an embodiment includes (A) quantum dots including a first functional group represented by Chemical Formula 1 and a second functional group including a *—OC(═O) group at the terminal end; and (B) a polymerizable compound.

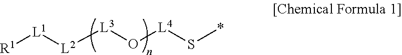

In Chemical Formula 1
R¹ is a substituted or unsubstituted C1 to C20 alkyl group, a substituted or unsubstituted C3 to C20 cycloalkyl group, a substituted or unsubstituted C3 to C20 cycloalkenyl group, a substituted or unsubstituted C2 to C20 heterocycloalkyl group, a substituted or unsubstituted C6 to C20 aryl group, or a fused ring group thereof,
L¹ to L⁴ are each independently a single bond, an ether group (*—O—*), or a substituted or unsubstituted C1 to C20 alkylene group, and
n is an integer from 1 to 20.

Since a current display market is changing toward producing clear light with smaller pixels and a thinner thickness, such as μ-LED and nano-LED, the curable composition according to an embodiment has very excellent light resistance reliability under high light resistance conditions and conforms to the current display market trend. On the contrary, a conventional quantum dot photoresist composition, which generally uses a thiol-based ligand as a quantum dot surface-modifying material, may improve light resistance reliability, compared with before the surface modification, but deteriorate a light retention rate (light resistance reliability) under the high light resistance conditions of Blue LED and thus has a problem of being not applied as backlight emitting very strong light such as μ-LED or nano-LED.

According to an embodiment, since the first functional group represented by Chemical Formula 1 and the second functional group including an *—OC(═O) group at the terminal end are simultaneously used as the quantum dot surface-modifying material, very excellent light resistance reliability may be achieved under the high light resistance conditions. Since the first functional group is derived from a thiol-based ligand, and the second functional group is derived from a carboxyl group ligand, when the thiol-based ligand and the carboxyl group ligand are simultaneously used as the quantum dot surface-modifying material, unlike when the thiol-based ligand and the carboxyl group ligand are respectively used as the quantum dot surface-modifying material, the light resistance reliability may be improved under the high light resistance conditions. Even when two different types of thiol-based ligands are used as the quantum dot surface-modifying material, or two different types of carboxyl group ligands are used as the quantum dot surface-modifying material, it is difficult to improve the light resistance reliability under the high light resistance conditions, and even though different series of ligands are used as the quantum dot surface-modifying material, any combination of thiol-based ligands and carboxyl group ligands as in the embodiment may be the most advantageous for improving the light resistance reliability under the high light resistance conditions.

Hereinafter, each component constituting the curable composition according to an embodiment will be described in detail.

### Quantum Dots

The most efficient ligand capable of passivating the surfaces of the quantum dots as an organic material ligand is, as is well known, a ligand having a thiol group, wherein a carboxylic acid-type ligand has relatively weak interaction with the surfaces of the quantum dots, and a phosphoric acid-type ligand has sufficient dispersibility of the quantum dots but a problem of lowering efficiency (causing color changes).

Since display technologies have been developed from LCD in the past to OLED, NED, and recent micro LED, which gradually increase intensity of blue light, the durability (particularly light resistance) of the quantum dots also needs to be significantly improved, compared with the current level.

Accordingly, in order to provide effective passivation of the quantum dot surface, by constructing a surface modification material with a combination of a thiol-based ligand (first functional group) and a carboxylic ligand (second functional group), when a quantum dot-containing curable composition surface-modified with the ligand is loaded as a single film on a display panel, even though exposed to strong blue light such as micro LED for a long time, the quantum dot-containing curable composition may maintain initial light efficiency and have very excellent light resistance reliability.

For example, the second functional group may be represented by Chemical Formula 2.

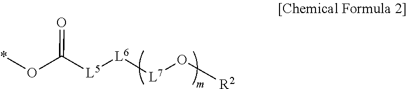

In Chemical Formula 2,
R² is a substituted or unsubstituted C1 to C20 alkyl group, a substituted or unsubstituted C3 to C20 cycloalkyl group, a substituted or unsubstituted C2 to C20 heterocycloalkyl group, a substituted or unsubstituted C6 to C20 aryl group, or *—C(═O)R³ wherein R³ is a C1 to C10 alkyl group or

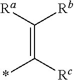

(wherein R^{a} to R^{c} are each independently a hydrogen atom or a C1 to C10 alkyl group),
L⁵ to L⁷ are each independently a single bond, an ether group (*—O—*), an ester group (*—C(═O)O—* or *—OC(═O)—*), or a substituted or unsubstituted C1 to C20 alkylene group, and
m is an integer of 1 to 20.

For example, Chemical Formula 2 may be represented by any one of Chemical Formula 2A to Chemical Formula 2C.

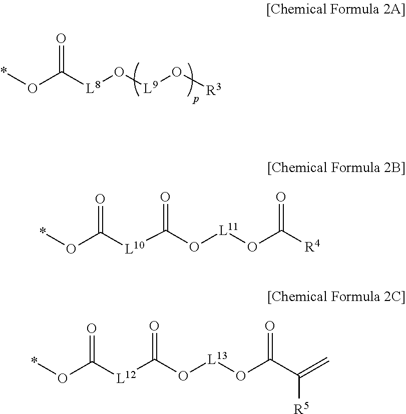

In Chemical Formula 2A to Chemical Formula 2C,
R³ to R⁵ are each independently a hydrogen atom or a substituted or unsubstituted C1 to C20 alkyl group,
L⁸ to L¹³ are each independently a substituted or unsubstituted C1 to C20 alkylene group, and
p is an integer of 1 to 20.

For example, the first functional group and the second functional group may be included in a molar ratio of 1:0.5 to 1:1.5. When the first functional group and the second functional group are included in the above molar ratio range, the light resistance reliability of the curable composition according to an embodiment can be maximized.

For example, the first functional group may be represented by at least one selected from Chemical Formula 1-1 to Chemical Formula 1-3, but is not necessarily limited thereto.

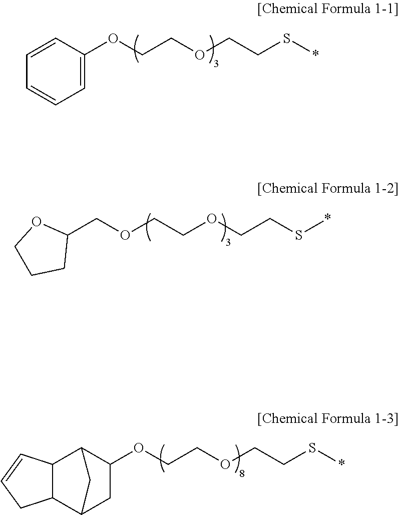

For example, the second functional group may be represented by at least one selected from Chemical Formula 2-1 to Chemical Formula 2-4, but is not necessarily limited thereto.

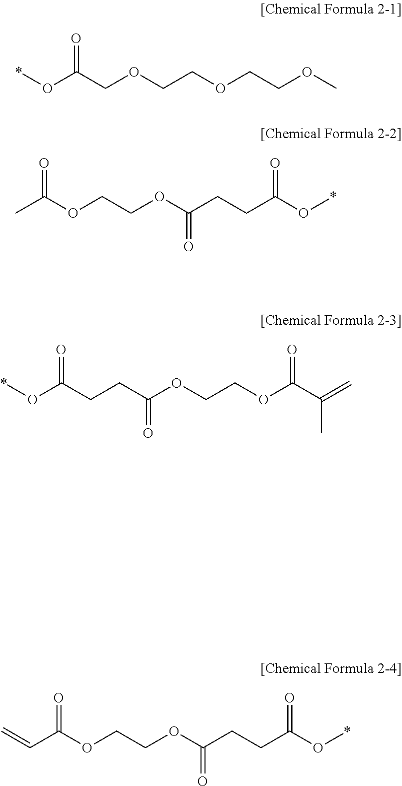

For example, the first functional group may be derived from a compound represented by Chemical Formula 3.

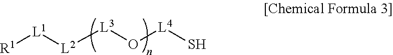

In Chemical Formula 3,
R¹ is a substituted or unsubstituted C1 to C20 alkyl group, a substituted or unsubstituted C3 to C20 cycloalkyl group, a substituted or unsubstituted C3 to C20 cycloalkenyl group, a substituted or unsubstituted C2 to C20 heterocycloalkyl group, a substituted or unsubstituted C6 to C20 aryl group, or a fused ring group thereof,
L¹ to L⁴ are each independently a single bond, an ether group (*—O—*), or a substituted or unsubstituted C1 to C20 alkylene group, and
n is an integer from 1 to 20.

For example, the compound represented by Chemical Formula 3 may be represented by at least one selected from Chemical Formula 3-1 to Chemical Formula 3-3, but is not necessarily limited thereto.

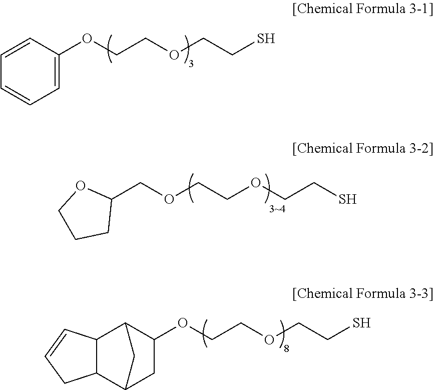

For example, the second functional group may be derived from a compound represented by Chemical Formula 4.

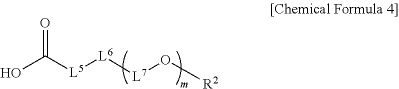

In Chemical Formula 4,
R² is a substituted or unsubstituted C1 to C20 alkyl group, a substituted or unsubstituted C3 to C20 cycloalkyl group, a substituted or unsubstituted C2 to C20 heterocycloalkyl group, a substituted or unsubstituted C6 to C20 aryl group, or *—C(═O)R³, wherein R³ is a C1 to C10 alkyl group or

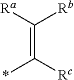

(wherein R^{a} to R^{c} are each independently a hydrogen atom or a C1 to C10 alkyl group),
L⁵ to L⁷ are each independently a single bond, an ether group (*—O—*), an ester group (*—C(═O)O—* or *—OC(═O)—*), or a substituted or unsubstituted C1 to C20 alkylene group, and
m is an integer of 1 to 20.

For example, the compound represented by Chemical Formula 4 may be represented by at least one selected from Chemical Formula 4-1 to Chemical Formula 4-4, but is not necessarily limited thereto.

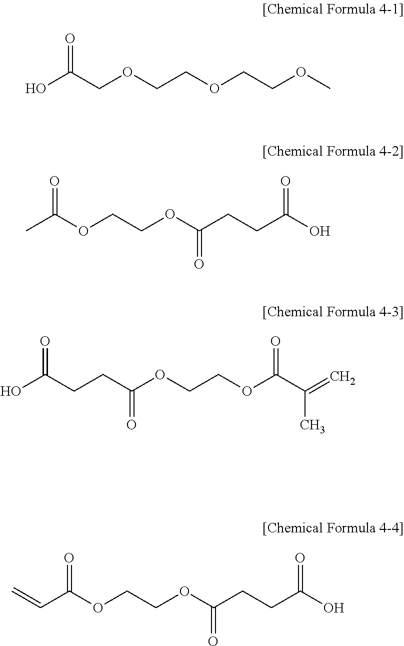

If the quantum dots surface-modified with the surface-modifying material are added to a polymerizable compound described later and stirred, a very transparent dispersion may be obtained, which is a criterion for confirming that the surface-modification of the quantum dots is very good.

For example, the quantum dots may have a maximum fluorescence emission wavelength at 500 nm to 680 nm.

For example, the quantum dots may be included in an amount of 1 wt % to 40 wt %, for example 3 wt % to 30 wt %, based on a total amount of the curable composition. If the quantum dots are included within the range, high light retention and light efficiency can be achieved even after curing.

For example, the quantum dots absorb light in a wavelength region of 360 nm to 780 nm, for example 400 nm to 780 nm and emits fluorescence in a wavelength region of 500 nm to 700 nm, for example 500 nm to 580 nm, or emits fluorescence in a wavelength region of 600 nm to 680 nm. That is, the quantum dots may have a maximum fluorescence emission wavelength (fluorescence λₑₘ) at 500 nm to 680 nm.

The quantum dots may each independently have a full width at half maximum (FWHM) of 20 nm to 100 nm, for example 20 nm to 50 nm. If the quantum dots have a full width at half maximum (FWHM) of the ranges, color reproducibility is increased when used as a color material in a color filter due to high color purity.

The quantum dots may each independently be an organic material, an inorganic material, or a hybrid (mixture) of an organic material and an inorganic material.

The quantum dots may each independently be composed of a core and a shell surrounding the core, and the core and the shell may each independently have a structure of a core, core/shell, core/first shell/second shell, alloy, alloy/shell, or the like, which is composed of Group II-IV, Group III-V, and the like, but are not limited thereto.

For example, the core may include at least at least one material selected from CdS, CdSe, CdTe, ZnS, ZnSe, ZnTe, HgS, HgSe, HgTe, GaN, GaP, GaAs, InP, InAs, and an alloy thereof, but is not necessarily limited thereto. The shell surrounding the core may include at least at least one material selected from CdSe, ZnSe, ZnS, ZnTe, CdTe, PbS, TiO, SrSe, HgSe, and an alloy thereof, but is not necessarily limited thereto.

In an embodiment, since an interest in an environment has been recently much increased over the whole world, and a restriction of a toxic material also has been fortified, a cadmium-free light emitting material (InP/ZnS, InP/ZnSe/ZnS, etc.) having little low quantum efficiency (quantum yield) but being environmentally-friendly instead of a light emitting material having a cadmium-based core is used, but not necessarily limited thereto.

In the case of the quantum dots of the core/shell structure, an entire size including the shell (an average particle diameter) may be 1 nm to 15 nm, for example, 5 nm to 15 nm.

For example, the quantum dots may each independently include red quantum dots, green quantum dots, or a combination thereof. The red quantum dots may each independently have an average particle diameter of 10 nm to 15 nm. The green quantum dots may each independently have an average particle diameter of 5 nm to 8 nm.

On the other hand, for dispersion stability of the quantum dot, the curable composition according to an embodiment may further include a dispersant. The dispersant helps uniform dispersibility of light conversion materials such as quantum dots in the curable composition and may include a non-ionic, anionic, or cationic dispersant. Specifically, the dispersant may be polyalkylene glycol or esters thereof, a polyoxy alkylene, a polyhydric alcohol ester alkylene oxide addition product, an alcohol alkylene oxide addition product, a sulfonate ester, a sulfonate salt, a carboxylate ester, a carboxylate salt, alkyl amide alkylene oxide addition product, alkyl amine and the like, and they may be used alone or in a mixture of two or more. The dispersant may be used in an amount of 0.1 wt % to 100 wt %, for example 10 wt % to 20 wt % based on a solid content of the light conversion material such as quantum dots.

### Polymerizable Compound

The curable composition according to an embodiment may include a polymerizable compound, and the polymerizable compound may have a carbon-carbon double bond at its terminal end.

For example, the polymerizable compound having the carbon-carbon double bond at the terminal end may have a molecular weight of 170 g/mol to 1,000 g/mol. If the polymerizable compound having the carbon-carbon double bond at the terminal end has a molecular weight within the range, it may be advantageous for ink-jetting because it does not increase a viscosity of the composition without hindering the optical characteristics of the quantum dots.

For example, the polymerizable compound having the carbon-carbon double bond at the terminal end may be represented by Chemical Formula 6, but is not necessarily limited thereto.

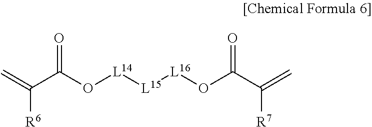

In Chemical Formula 6,
R⁶ and R⁷ are each independently a hydrogen atom or a substituted or unsubstituted C1 to C10 alkyl group,
L¹⁴ and L¹⁶ are each independently a single bond or a substituted or unsubstituted C1 to C10 alkylene group, and
L¹⁵ is a substituted or unsubstituted C1 to C10 alkylene group, a substituted or unsubstituted C3 to C20 cycloalkylene group, or an ether group (*—O—*).

For example, the polymerizable compound having a carbon-carbon double bond at the terminal end may be represented by Chemical Formula 6-1, Chemical Formula 6-2, or Chemical Formula 6-3, but is not necessarily limited thereto.

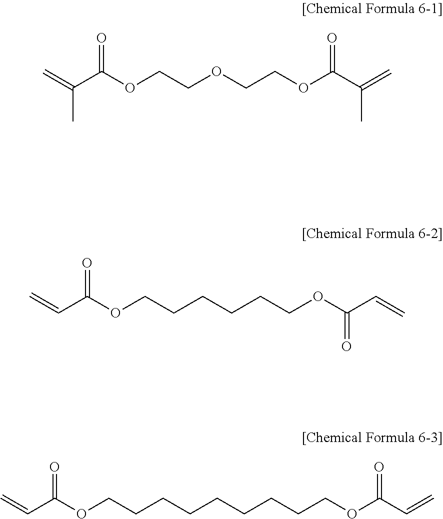

For example, the polymerizable compound having the carbon-carbon double bond at the terminal end may further include ethylene glycoldiacrylate, triethylene glycoldiacrylate, 1,4-butanedioldiacrylate, 1,6-hexanedioldiacrylate, neopentylglycoldiacrylate, pentaerythritoldiacrylate, pentaerythritoltriacrylate, dipentaerythritoldiacrylate, dipentaerythritoltriacrylate, dipentaerythritolpentaacrylate, pentaerythritolhexaacrylate, bisphenol A diacrylate, trimethylolpropanetriacrylate, novolac epoxyacrylate, ethylene glycoldimethacrylate, triethylene glycoldimethacrylate, propylene glycoldimethacrylate, 1,4-butanedioldimethacrylate, 1,6-hexanedioldimethacrylate, or a combination thereof in addition to the aforementioned compound of Chemical Formula 6-1, Chemical Formula 6-2, or Chemical Formula 6-3.

In addition, together with the polymerizable compound having the carbon-carbon double bond at the terminal end, a generally-used monomer of a conventional thermosetting or photocurable composition may be further included. For example the monomer further include an oxetane-based compound such as bis[1-ethyl (3-oxetanyl)]methyl ether, and the like.

In addition, when the curable composition includes a solvent, based on a total amount of the curable composition, the polymerizable compound may be included in an amount of 1 wt % to 20 wt %, 1 wt % to 15 wt %, for example, 1 wt % to 10 wt %. If the polymerizable compound is included within the above range, optical characteristics of the quantum dots may be improved.

### Liqht Diffusing Agent

The curable composition according to an embodiment may further include a light diffusing agent.

For example, the light diffusing agent may include barium sulfate (BaSO₄), calcium carbonate (CaCO₃), titanium dioxide (TiO₂), zirconia (ZrO₂), or a combination thereof.

The light diffusing agent may reflect unabsorbed light in the aforementioned quantum dots and allows the quantum dots to absorb the reflected light again. That is, the light diffusing agent may increase an amount of light absorbed by the quantum dots and increase light conversion efficiency of the curable composition.

The light diffusing agent may have an average particle diameter (D₅₀) of 150 nm to 250 nm, and specifically 180 nm to 230 nm. If the average particle diameter of the light diffusing agent is within the ranges, it may have a better light diffusing effect and increase light conversion efficiency.

The light diffusing agent may be included in an amount of 1 wt % to 20 wt %, for example, 2 wt % to 15 wt %, for example, 3 wt % to 10 wt % based on a total amount of the curable composition. If the light diffusing agent is included in an amount of less than 1 wt % based on a total amount of the curable composition, it is difficult to expect a light conversion efficiency improvement effect due to the use of the light diffusing agent, while if it is included in an amount of greater than 20 wt %, there is a possibility that the quantum dots may be precipitated.

### Polymerization Initiator

The curable composition according to an embodiment may further include a polymerization initiator, for example, a photopolymerization initiator, a thermal polymerization initiator, or a combination thereof.

The photopolymerization initiator is a generally-used initiator for a photosensitive resin composition, for example an acetophenone-based compound, a benzophenone-based compound, a thioxanthone-based compound, a benzoin-based compound, a triazine-based compound, an oxime-based compound, an aminoketone-based compound, and the like, but is not necessarily limited thereto.

Examples of the acetophenone-based compound may be 2,2′-diethoxy acetophenone, 2,2′-dibutoxy acetophenone, 2-hydroxy-2-methylpropinophenone, p-t-butyltrichloro acetophenone, p-t-butyldichloro acetophenone, 4-chloro acetophenone, 2,2′-dichloro-4-phenoxy acetophenone, 2-methyl-1-(4-(methylthio)phenyl)-2-morpholinopropan-1-one, 2-benzyl-2-dimethylamino-1-(4-morpholinophenyl)-butan-1-one, and the like.

Examples of the benzophenone-based compound may be benzophenone, benzoyl benzoate, benzoyl methyl benzoate, 4-phenyl benzophenone, hydroxybenzophenone, acrylated benzophenone, 4,4′-bis(dimethyl amino)benzophenone, 4,4′-bis(diethylamino)benzophenone, 4,4′-dimethylaminobenzophenone, 4,4′-dichlorobenzophenone, 3,3′-dimethyl-2-methoxybenzophenone, and the like.

Examples of the thioxanthone-based compound may be thioxanthone, 2-methylthioxanthone, isopropyl thioxanthone, 2,4-diethyl thioxanthone, 2,4-diisopropyl thioxanthone, 2-chlorothioxanthone, and the like.

Examples of the benzoin-based compound may be benzoin, benzoin methyl ether, benzoin ethyl ether, benzoin isopropyl ether, benzoin isobutyl ether, benzyldimethylketal, and the like.

Examples of the triazine-based compound may be 2,4,6-trichloro-s-triazine, 2-phenyl-4,6-bis(trichloromethyl)-s-triazine, 2-(3′,4′-dimethoxystyryl)-4,6-bis(trichloromethyl)-s-triazine, 2-(4′-methoxynaphthyl)-4,6-bis(trichloromethyl)-s-triazine, 2-(p-methoxyphenyl)-4,6-bis(trichloromethyl)-s-triazine, 2-(p-tolyl)-4,6-bis(trichloromethyl)-s-triazine, 2-biphenyl-4,6-bis(trichloro methyl)-s-triazine, bis(trichloromethyl)-6-styryl-s-triazine, 2-(naphtho1-yl)-4,6-bis(trichloromethyl)-s-triazine, 2-(4-methoxynaphtho1-yl)-4,6-bis(trichloromethyl)-s-triazine, 2-4-bis(trichloromethyl)-6-piperonyl-s-triazine, 2-4-bis(trichloromethyl)-6-(4-methoxystyryl)-s-triazine, and the like.

Examples of the oxime-based compound may be O-acyloxime-based compound, 2-(O-benzoyloxime)-1-[4-(phenylthio)phenyl]-1,2-octandione, 1-(O-acetyloxime)-1-[9-ethyl-6-(2-methylbenzoyl)-9H-carbazol-3-yl]ethanone, O-ethoxycarbonyl-α-oxyamino-1-phenylpropan-1-one, and the like. Specific examples of the O-acyloxime-based compound may be 1,2-octandione, 2-dimethylamino-2-(4-methylbenzyl)-1-(4-morpholin-4-yl-phenyl)-butan-1-one, 1-(4-phenylsulfanyl phenyl)-butane-1,2-dione-2-oxime-O-benzoate, 1-(4-phenylsulfanyl phenyl)-octane-1,2-dione-2-oxime-O-benzoate, 1-(4-phenylsulfanyl phenyl)-octan-1-oneoxime-O-acetate, 1-(4-phenylsulfanyl phenyl)-butan-1-oneoxime-O-acetate, and the like.

Examples of the aminoketone-based compound may be 2-benzyl-2-dimethylamino-1-(4-morpholinophenyl)-butanone-1, and the like.

The photopolymerization initiator may further include a carbazole-based compound, a diketone-based compound, a sulfonium borate-based compound, a diazo-based compound, an imidazole-based compound, a biimidazole-based compound, and the like, besides the compounds.

The photopolymerization initiator may be used with a photosensitizer capable of causing a chemical reaction by absorbing light and becoming excited and then, transferring its energy.

Examples of the photosensitizer may be tetraethylene glycol bis-3-mercapto propionate, pentaerythritol tetrakis-3-mercapto propionate, dipentaerythritol tetrakis-3-mercapto propionate, and the like.

Examples of the thermal polymerization initiator may be peroxide, specifically benzoyl peroxide, dibenzoyl peroxide, lauryl peroxide, dilauryl peroxide, di-tert-butyl peroxide, cyclohexane peroxide, methyl ethyl ketone peroxide, hydroperoxide (e.g., tert-butyl hydroperoxide, cumene hydroperoxide), dicyclohexyl peroxydicarbonate, 2,2-azo-bis(isobutyronitrile), t-butyl perbenzoate, and the like, for example 2,2′-azobis-2-methylpropinonitrile, but are not necessarily limited thereto and any of which is well known in the art may be used.

The polymerization initiator may be included in an amount of 0.1 wt % to 5 wt %, for example 0.1 wt % to 3 wt % based on a total amount of the curable composition. If the polymerization initiator is included in the ranges, it is possible to obtain excellent reliability due to sufficient curing during exposure or thermal curing and to prevent deterioration of transmittance due to non-reaction initiators, thereby preventing deterioration of optical characteristics of the quantum dots.

### Binder Resin

The curable composition according to an embodiment may further include a binder resin.

The binder resin may include an acrylic resin, a cardo-based resin, an epoxy resin, or a combination thereof.

The acrylic resin may be a copolymer of a first ethylenic unsaturated monomer and a second ethylenic unsaturated monomer that is copolymerizable therewith, and may be resin including at least one acryl-based repeating unit.

Specific examples of the acrylic resin may be polybenzylmethacrylate, a (meth)acrylic acid/benzylmethacrylate copolymer, a (meth)acrylic acid/benzylmethacrylate/styrene copolymer, a (meth)acrylic acid/benzylmethacrylate/2-hydroxyethylmethacrylate copolymer, a (meth)acrylic acid/benzylmethacrylate/styrene/2-hydroxyethylmethacrylate copolymer, and the like, but are not limited thereto, and may be used alone or as a mixture of two or more.

A weight average molecular weight of the acrylic resin may be 5,000 g/mol to 15,000 g/mol. If the acrylic resin has a weight average molecular weight within the ranges, close contacting properties to a substrate, physical and chemical properties are improved, and a viscosity is appropriate.

An acid value of the acrylic resin may be 80 mgKOH/g to 130 mgKOH/g. If the acrylic resin has an acid value within the ranges, excellent resolution of a pixel may be obtained.

The cardo-based resin may be used in a conventional curable resin (or photosensitive resin) composition, for example, one suggested in Korean Patent Publication No. 10-2018-0067243 may be used, but is not limited thereto.

The cardo-based resin may be, for example prepared by mixing at least two of a fluorene-containing compound such as 9,9-bis(4-oxiranylmethoxyphenyl)fluorene; an anhydride compound such as benzenetetracarboxylic acid dianhydride, naphthalenetetracarboxylic acid dianhydride, biphenyltetracarboxylic acid dianhydride, benzophenonetetracarboxylic acid dianhydride, pyromellitic dianhydride, cyclobutanetetracarboxylic acid dianhydride, perylenetetracarboxylic acid dianhydride, tetrahydrofurantetracarboxylic acid dianhydride, and tetrahydrophthalic anhydride; a glycol compound such as ethylene glycol, propylene glycol, and polyethylene glycol; an alcohol compound such as methanol, ethanol, propanol, n-butanol, cyclohexanol, and benzylalcohol; a solvent-based compound such as propylene glycol methylethylacetate, and N-methylpyrrolidone; a phosphorus compound such as triphenylphosphine; and an amine or ammonium salt compound such as tetramethylammonium chloride, tetraethylammonium bromide, benzyldiethylamine, triethylamine, tributylamine, or benzyl triethylammonium chloride.

A weight average molecular weight of the cardo-based binder resin may be 500 g/mol to 50,000 g/mol, for example 1,000 g/mol to 30,000 g/mol. If the weight average molecular weight of the cardo-based binder resin is within the ranges, a satisfactory pattern may be formed without a residue during a production of a cured layer and without losing a film thickness during development of the curable composition.

If the binder resin is a cardo-based resin, the curable composition including the same, particularly the photosensitive resin composition has excellent developability and sensitivity during photo-curing and thus, fine pattern-forming capability.

The epoxy resin may be a thermally polymerizable monomer or oligomer, and may include a compound having a carbon-carbon unsaturated bond and a carbon-carbon cyclic bond.

The epoxy resin may further include a bisphenol A epoxy resin, a bisphenol F epoxy resin, a phenol novolac epoxy resin, a cyclic aliphatic epoxy resin, and an aliphatic polyglycidyl ether, but is not necessarily limited thereto.

As commercially available products of the compounds, a bisphenol epoxy resin may be YX4000, YX4000H, YL6121H, YL6640, or YL6677 of Yuka Shell Epoxy Co., Ltd.; a cresol novolac epoxy resin may be EOCN-102, EOCN-103S, EOCN-104S, EOCN-1020, EOCN-1025, and EOCN-1027 of Nippon Kayaku Co., Ltd. and EPIKOTE 180S75, and the like of Yuka Shell Epoxy Co., Ltd.; a bisphenol A epoxy resin may be EPIKOTE 1001, 1002, 1003, 1004, 1007, 1009, 1010, and 828 of Yuka Shell Epoxy Co., Ltd.; a bisphenol F epoxy resin may be EPIKOTE 807 and 834 of Yuka Shell Epoxy Co., Ltd.; a phenol novolac epoxy resin may be EPIKOTE 152, 154, or 157H65 of Yuka Shell Epoxy Co, Ltd. and EPPN 201, 202 of Nippon Kayaku Co., Ltd. and EPPN 201, 202 of Nippon Kayaku Co., Ltd.; a cyclic aliphatic epoxy resin may be CY175, CY177, and CY179 of CIBA-GEIGY A.G Corp., ERL-4234, ERL-4299, ERL-4221 and ERL-4206 of U.C.C., Showdyne 509 of Showa Denko K.K., Araldite CY-182, CY-192 and CY-184 of CIBA-GEIGY A.G Corp., EPICLON 200 and 400 of Dainippon Ink & Chemicals Inc., EPIKOTE 871 and 872, and EP1032H60 of Yuka Shell Epoxy Co., Ltd., ED-5661 and ED-5662 of Celanese Coating Corporation; an aliphatic polyglycidylether may be EPIKOTE 190P and 191 P of Yuka Shell Epoxy Co., Ltd., EPOLITE 100MF of Kyoeisha Yushi Kagaku Kogyo Co., Ltd., EPIOL TMP of Nihon Yushi K. K., and the like.

For example, the binder resin may be included in an amount of 1 wt % to 30 wt %, for example 3 wt % to 20 wt % based on a total amount of the curable composition. In this case, pattern characteristics, heat resistance, and chemical resistance may be improved.

### Other Additives

For stability and dispersion improvement of the quantum dot, the curable composition according to an embodiment may further include a polymerization inhibitor.

The polymerization inhibitor may include a hydroquinone-based compound, a catechol-based compound, or a combination thereof, but is not necessarily limited thereto. When the curable composition according to an embodiment further includes the hydroquinone-based compound, the catechol-based compound, or the combination thereof, room temperature cross-linking during exposure after coating the curable composition may be prevented.

For example, the hydroquinone-based compound, the catechol-based compound, or the combination thereof may be hydroquinone, methyl hydroquinone, methoxyhydroquinone, t-butyl hydroquinone, 2,5-di-t-butyl hydroquinone, 2,5-bis(1,1-dimethylbutyl) hydroquinone, 2,5-bis(1,1,3,3-tetramethylbutyl) hydroquinone, catechol, t-butyl catechol, 4-methoxyphenol, pyrogallol, 2,6-di-t-butyl-4-methylphenol, 2-naphthol, tris(N-hydroxy-N-nitrosophenylaminato-O,O′)aluminum, or a combination thereof, but are not necessarily limited thereto.

The hydroquinone-based compound, the catechol-based compound, or the combination thereof may be used in a form of dispersion. The polymerization inhibitor in a form of dispersion may be included in an amount of 0.001 wt % to 3 wt %, for example 0.01 wt % to 2 wt % based on a total amount of the curable composition. If the polymerization inhibitor is included in the ranges, passage of time at room temperature may be solved and simultaneously sensitivity deterioration and surface delamination phenomenon may be prevented.

In addition, the curable composition according to an embodiment may further include malonic acid; 3-amino-1,2-propanediol; a silane-based coupling agent; a leveling agent; a fluorine-based surfactant; or a combination thereof in order to improve heat resistance and reliability.

For example, the curable composition according to embodiment may further include a silane-based coupling agent having a reactive substituent such as a vinyl group, a carboxyl group, a methacryloxy group, an isocyanate group, an epoxy group, and the like in order to improve close contacting properties with a substrate.

Examples of the silane-based coupling agent may be trimethoxysilyl benzoic acid, γ-methacryl oxypropyl trimethoxysilane, vinyl triacetoxysilane, vinyl trimethoxysilane, γ-isocyanate propyl triethoxysilane, γ-glycidoxy propyl trimethoxysilane, β-epoxycyclohexylethyltrimethoxysilane, and the like, and these may be used alone or in a mixture of two or more.

The silane-based coupling agent may be used in an amount of 0.01 parts by weight to 10 parts by weight based on 100 parts by weight of the curable composition. If the silane-based coupling agent is included within the range, close contacting properties, storage capability, and the like are improved.

In addition, the curable composition may further include a surfactant, for example a fluorine-based surfactant as needed in order to improve coating properties and inhibit generation of spots, that is, improve leveling performance.

The fluorine-based surfactant may have a low weight average molecular weight of 4,000 g/mol to 10,000 g/mol, and specifically 6,000 g/mol to 10,000 g/mol. In addition, the fluorine-based surfactant may have a surface tension of 18 mN/m to 23 mN/m (measured in a 0.1% polyethylene glycol monomethylether acetate (PGMEA) solution). If the fluorine-based surfactant has a weight average molecular weight and a surface tension within the ranges, leveling performance may be further improved, and excellent characteristics may be provided when slit coating as high-speed coating is applied since film defects may be less generated by preventing a spot generation during the high-speed coating and suppressing a vapor generation.

Examples of the fluorine-based surfactant may be, BM-1000®, and BM-1100® (BM Chemie Inc.); MEGAFACE F 142D®, F 172®, F 173®, and F 183® (Dainippon Ink Kagaku Kogyo Co., Ltd.); FULORAD FC-135®, FULORAD FC-170C®, FULORAD FC-430®, and FULORAD FC-431® (Sumitomo 3M Co., Ltd.); SURFLON S-112®, SURFLON S-113®, SURFLON S-131®, SURFLON S-141®, and SURFLON S-145® (ASAHI Glass Co., Ltd.); and SH-28PA®, SH-190®, SH-193®, SZ-6032®, and SF-8428®, and the like (Toray Silicone Co., Ltd.); F-482, F-484, F-478, F-554 and the like of DIC Co., Ltd.

In addition, the curable composition according to an embodiment may include a silicone-based surfactant in addition to the fluorine-based surfactant. Specific examples of the silicone-based surfactant may be TSF400, TSF401, TSF410, TSF4440, and the like of Toshiba silicone Co., Ltd., but are not limited thereto.

The surfactant may be included in an amount of 0.01 parts by weight to 5 parts by weight, for example 0.1 parts by weight to 2 parts by weight based on 100 parts by weight of the curable composition. If the surfactant is included within the ranges, foreign materials are less produced in a sprayed composition.

In addition, the curable composition according to an embodiment may further include other additives such as an antioxidant, a stabilizer, and the like in a predetermined amount, unless properties are deteriorated.

### Solvent

Meanwhile, the curable composition according to an embodiment may further include a solvent.

The solvent may for example include alcohols such as methanol, ethanol, and the like; glycol ethers such as ethylene glycol methylether, ethylene glycol ethylether, propylene glycol methylether, and the like; cellosolve acetates such as methyl cellosolve acetate, ethyl cellosolve acetate, diethyl cellosolve acetate, and the like; carbitols such as methylethyl carbitol, diethyl carbitol, diethylene glycol monomethylether, diethylene glycol monoethylether, diethylene glycol dimethylether, diethylene glycol methylethylether, diethylene glycol diethylether, and the like; propylene glycol alkylether acetates such as propylene glycol monomethylether acetate, propylene glycol propylether acetate, and the like; ketones such as methylethylketone, cyclohexanone, 4-hydroxy-4-methyl-2-pentanone, methyl-n-propylketone, methyl-n-butylketone, methyl-n-amylketone, 2-heptanone, and the like; saturated aliphatic monocarboxylic acid alkyl esters such as ethyl acetate, n-butyl acetate, isobutyl acetate, and the like; lactate esters such as methyl lactate, ethyl lactate, and the like; hydroxy acetic acid alkyl esters such as methyl hydroxyacetate, ethyl hydroxyacetate, butyl hydroxyacetate, and the like; acetic acid alkoxyalkyl esters such as methoxymethyl acetate, methoxyethyl acetate, methoxybutyl acetate, ethoxymethyl acetate, ethoxyethyl acetate, and the like; 3-hydroxypropionic acid alkyl esters such as methyl 3-hydroxypropionate, ethyl 3-hydroxypropionate, and the like; 3-alkoxypropionic acid alkyl esters such as methyl 3-methoxypropionate, ethyl 3-methoxypropionate, ethyl 3-ethoxypropionate, methyl 3-ethoxypropionate, and the like; 2-hydroxypropionic acid alkyl ester such as methyl 2-hydroxypropionate, ethyl 2-hydroxypropionate, propyl 2-hydroxypropionate, and the like; 2-alkoxypropionic acid alkyl esters such as methyl 2-methoxypropionate, ethyl 2-methoxypropionate, ethyl 2-ethoxypropionate, methyl 2-ethoxypropionate, and the like; 2-hydroxy-2-methylpropionic acid alkyl esters such as methyl 2-hydroxy-2-methylpropionate, ethyl 2-hydroxy-2-methylpropionate, and the like; 2-alkoxy-2-methylpropionic acid alkyl esters such as methyl 2-methoxy-2-methylpropionate, ethyl 2-ethoxy-2-methylpropionate, and the like; esters such as 2-hydroxyethyl propionate, 2-hydroxy-2-methylethyl propionate, hydroxyethyl acetate, methyl 2-hydroxy-3-methylbutanoate, and the like; or ketonate esters such as ethyl pyruvate, and the like, and in addition, may be N-methylformamide, N,N-dimethyl formamide, N-methylformanilide, N-methylacetamide, N,N-dimethyl acetamide, N-methylpyrrolidone, dimethylsulfoxide, benzylethylether, dihexylether, acetylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, phenyl cellosolve acetate, and the like, but is not limited thereto.

For example, the solvent may be desirably glycol ethers such as ethylene glycol monoethylether, ethylene diglycolmethylethylether, and the like; ethylene glycol alkylether acetates such as ethyl cellosolve acetate, and the like; esters such as 2-hydroxy ethyl propionate, and the like; carbitols such as diethylene glycol monomethylether, and the like; propylene glycol alkylether acetates such as propylene glycol monomethylether acetate, propylene glycol propylether acetate, and the like; alcohols such as ethanol, and the like, or a combination thereof.

For example, the solvent may be a polar solvent including propylene glycol monomethylether acetate, dipropylene glycol methylether acetate, ethanol, ethylene glycoldimethylether, ethylenediglycolmethylethylether, diethylene glycoldimethylether, 2-butoxyethanol, N-methylpyrrolidine, N-ethylpyrrolidine, propylene carbonate, γ-butyrolactone, or a combination thereof.

The solvent may be included in a balance amount, for example 40 wt % to 80 wt %, for example 45 wt % to 80 wt %, based on the total amount of the curable composition. If the solvent is within the range, the solvent type curable composition has appropriate viscosity and thus may have excellent coating property when coated in a large area through spin-coating and slit-coating.

Another embodiment provides a cured layer produced using the aforementioned curable composition, and a display device including the cured layer. For example, the display device may include a micro LED light source.

One of the methods for manufacturing the cured layer is to manufacture the cured layer using a lithography method using the curable composition, and the manufacturing method is as follows.

### (1) Coating and Film Formation

The curable composition is coated to have a desired thickness, for example, a thickness ranging from 2 μm to 10 μm, on a substrate which undergoes a predetermined pretreatment, using a spin or slit coating method, a roll coating method, a screen-printing method, an applicator method, and the like. Then, the coated substrate is heated at a temperature of 70° C. to 90° C. for 1 minute to 10 minutes to remove a solvent and to form a film.

### (2) Exposure

The resultant film is irradiated by an actinic ray such as a UV ray of 190 nm to 450 nm, for example 200 nm to 400 nm after putting a mask with a predetermined shape to form a desired pattern. As a light source used for irradiation, a low-pressure mercury lamp, high-pressure mercury lamp, ultra-high-pressure mercury lamp, metal halide lamp, argon gas laser, i-line, KrF, ArF, I-ArF, EUV, X-ray, electron beam, etc. may be used as needed.

Exposure process uses, for example, a light dose of 500 mJ/cm² or less (with a 365 nm sensor) when a high-pressure mercury lamp is used. However, the light dose may vary depending on types of each component of the curable composition, its combination ratio, and a dry film thickness.

### (3) Development

After the exposure process, an alkali aqueous solution is used to develop the exposed film by dissolving and removing an unnecessary part except the exposed part, forming an image pattern. In other words, when the alkali developing solution is used for the development, an unexposed region is dissolved, and an image color filter pattern is formed.

### (4) Post-Treatment

The developed image pattern may be heated again or irradiated by an actinic ray and the like for curing, in order to accomplish excellent quality in terms of heat resistance, light resistance, close contacting properties, crack-resistance, chemical resistance, high strength, storage stability, and the like.

### MODE FOR INVENTION

Hereinafter, the present invention is illustrated in more detail with reference to examples. These examples, however, are not in any sense to be interpreted as limiting the scope of the invention.

### (Synthesis of Surface-Modifying Materials)

### Synthesis Example 1

100 g of PH-4 (Hannong Chemical Inc.) is added to a two-necked round bottom flask and then, sufficiently dissolved in 300 mL of THF (tetrahydrofuran). Subsequently, 15.4 g of NaOH and 100 mL of water are added thereto at 0° C. and then, sufficiently dissolved until a clear solution is obtained. Then, a solution prepared by dissolving 73 g of para-toluene sulfonic chloride in 100 mL of THF is slowly injected thereinto at 0° C. The injection proceeds for 1 hour, and the obtained mixture is stirred at room temperature for 12 hours. When a reaction is completed, after adding an excessive amount of methylene chloride thereto and then, stirring them, a saturated NaHCO₃ solution is added thereto and then, proceeds with extraction, titration, and moisture removal. After removing the solvent, the residue is dried under a reduced pressure for 24 hours. 50 g of the dried product is added to a two-necked round bottom flask and then, sufficiently stirred in 300 mL of ethanol. Subsequently, 27 g of thiourea is added thereto and dispersed therein and then, refluxed at 80° C. for 12 hours. After injecting an aqueous solution of 4.4 g of NaOH dissolved in 20 mL of water, adding an excessive amount of methylene chloride thereto, while further stirring for 5, and then, stirring the mixture, a hydrochloric acid aqueous solution is added thereto to proceed with extraction, titration, moisture removal, and solvent removal in order. A product therefrom is dried under a reduced pressure for 24 hours to obtain a compound represented by Chemical Formula 3-1.

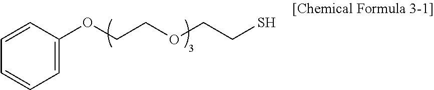

### Synthesis Example 2

100 g of THF-4 (Hannong Chemical Inc.) is added to a two-necked round bottom flask and then, sufficiently dissolved in THF. Subsequently, 43.1 g of NaOH and 100 mL of water are added thereto at 0° C. and then, sufficiently dissolved, until a clear solution is obtained. Then, a solution prepared by dissolving 102.7 g of para-toluene sulfonic chloride in 100 mL of THF is slowly added thereto at 0° C. The injection proceeds for 1 hour, and the mixture is stirred at room temperature for 12 hours. When a reaction is completed, after adding an excessive amount of methylene chloride thereto and then, stirring the mixture, a saturated NaHCO₃ solution is added thereto and then, proceeds with extraction, titration, and moisture removal. After removing the solvent, the residue is dried under a reduced pressure for 24 hours. 150 g of the dried product is added to a two-necked round bottom flask and then, sufficiently stirred in 1.5 L of ethanol. Subsequently, 47.5 g of thiourea is added thereto and dispersed therein and then, refluxed at 80° C. for 12 hours. After injecting an aqueous solution of 13.2 g of NaOH dissolved in 60 mL of water thereinto, adding an excessive amount of methylene chloride thereto, while further stirring for 5 hours, and then, stirring the mixture, a hydrochloric acid aqueous solution is added thereto and then, proceeds sequentially with extraction, titration, moisture removal, and solvent removal. A product therefrom is dried for 24 hours under a reduced pressure to obtain a compound represented by Chemical Formula 3-2.

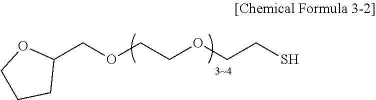

### Synthesis Example 3

100 g of HDCP-4 (Hannong Chemical Inc.) is added to a two-necked round bottom and then, sufficiently dissolved in 300 mL of THF. Subsequently, 49.0 g of NaOH and 100 mL of water are added thereto and then, sufficiently dissolved therein at 0° C. until a clear solution is obtained. Then, a solution prepared by dissolving 116.8 g of para-toluene sulfonic chloride in 100 mL of THF is slowly injected thereinto at 0° C. The injection proceeds for 1 hour, and the mixture is stirred at room temperature for 12 hours. When a reaction is completed, after adding methylene chloride thereto and then, stirring the mixture, a NaHCO₃ saturation solution is added thereto and then, proceeds with extraction, titration, and moisture removal. After removing the solvent, the residue is dried for 12 hours under a reduced pressure. 140 g of the dried product is added to a two-necked round bottom flask and sufficiently stirred in 1.5 L of ethanol. Subsequently, 41.9 g of thiourea is added thereto and dispersed therein and then, refluxed at 80° C. for 12 hours. After injecting an aqueous solution of 13.2 g of NaOH dissolved in 60 mL of water thereinto, adding an excessive amount of methylene chloride thereto, while further stirring for 5 hours, and then, stirring the mixture, a hydrochloric acid aqueous solution is added thereto and then, proceeds sequentially with extraction, titration, and moisture removal, and solvent removal. A product therefrom is dried under a reduced pressure for 24 hours to obtain a compound represented by Chemical Formula 3-3.

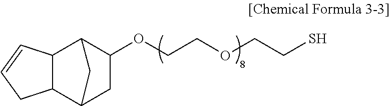

### Synthesis Example 4

10 g of 2-hydroxyethyl acetate is added to a round-bottomed flask and then, sufficiently dissolved in 150 mL of CH₂Cl₂. Subsequently, 9.6 g of succinic anhydride and 0.1 g of DMAP (4-dimethylaminopyridine) are added thereto and then, stirred at room temperature for 13 hours. The reactant is washed with 100 mL of a 1N HCl aqueous solution and additionally washed with 100 mL of water, and an organic layer therefrom is dried under a reduced pressure to obtain a compound represented by Chemical Formula 4-2.

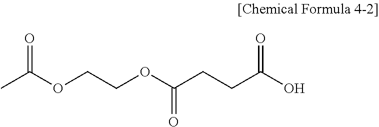

### Synthesis Example 5

12.5 g of 2-hydroxyethyl methacrylate is added to a round bottom flask and then, sufficiently dissolved in 150 mL of CH₂Cl₂. Subsequently, 9.6 g of succinic anhydride and 0.1 g of DMAP are added thereto and then, stirred at room temperature for 13 hours. The reactant is washed with 120 mL of a 1N HCl aqueous solution and additionally, washed with 120 mL of water, and an organic layer therefrom is dried under a reduced pressure to obtain a compound represented by Chemical Formula 4-3.

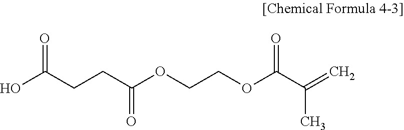 [SMILES: C=C(C)C(=O)OCCOC(=O)CCC(=O)O]

### Synthesis Example 6

11.2 g of 2-hydroxyethyl acrylate is added to a round bottom flask and then, sufficiently dissolved in 150 mL of CH₂Cl₂. Subsequently, 9.6 g of succinic anhydride and 0.1 g of DMAP are added thereto and then, stirred at room temperature for 13 hours. The reactant is washed with 110 mL of a 1N HCl aqueous solution and additionally washed with 110 mL of water, and an organic layer therefrom is dried under a reduced pressure to obtain a compound represented by Chemical Formula 4-4.

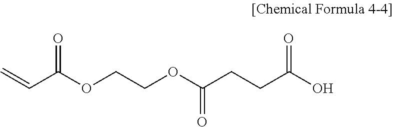

### (Preparation of Surface-Modified Quantum Dots)

After putting a magnetic bar in a 3-necked round bottom flask, a green quantum dot dispersion solution (26 wt % of quantum dot solid; InP/ZnSe/ZnS, Hansol Chemical) is put therein. Then, surface-modifying material according to Synthesis Examples 1 to 6 are added thereto and then, stirred at 80° C. under a nitrogen atmosphere. When a reaction is completed, the quantum dot reaction solution is cooled to room temperature (23° C.) and added to cyclohexane to catch precipitates. The precipitates are separated from the cyclohexane through centrifugation and sufficiently dried in a vacuum oven for one day, obtaining surface-modified green quantum dots.

### (Preparation of Curable Compositions)

Based on each of the following components, curable compositions according to Examples 1 to 10 and Comparative Examples 1 to 8 were prepared.

### (A) Quantum Dots

(A-1) Green quantum dots surface-modified with the compound of Chemical Formula 3-1 and the compound of Chemical Formula 4-1 (M2963, TCI) (molar ratio=1:1)

(A-2) Green quantum dots surface-modified with the compound of Chemical Formula 3-2 and the compound of Chemical Formula 4-1 (molar ratio=1:1)

(A-3) Green quantum dots surface-modified with the compound of Chemical Formula 3-3 and the compound of Chemical Formula 4-1 (molar ratio=1:1)

(A-4) Green quantum dots surface-modified with the compound of Chemical Formula 3-1 and the compound of Chemical Formula 4-1 (molar ratio=1:0.5)

(A-5) Green quantum dots surface-modified with the compound of Chemical Formula 3-1 and the compound of Chemical Formula 4-1 (molar ratio=1:1.5)

(A-6) Green quantum dots surface-modified with the compound of Chemical Formula 3-1 and the compound of Chemical Formula 4-1 (molar ratio=1:0.3)

(A-7) Green quantum dots surface-modified with the compound of Chemical Formula 3-1 and the compound of Chemical Formula 4-1 (molar ratio=1:1.2)

(A-8) Green quantum dots surface-modified with the compound of Chemical Formula 3-1 and the compound of Chemical Formula 4-2 (molar ratio=1:1)

(A-9) Green quantum dots surface-modified with the compound of Chemical Formula 3-1 and the compound of Chemical Formula 4-3 (molar ratio=1:1)

(A-10) Green quantum dots surface-modified with the compound of Chemical Formula 3-1 and the compound of Chemical Formula 4-4 (molar ratio=1:1)

(A-11) Green quantum dots surface-modified with the compound of Chemical Formula 3-1

(A-12) Green quantum dots surface-modified with the compound of Chemical Formula 3-2

(A-13) Green quantum dots surface-modified with the compound of Chemical Formula 3-3

(A-14) Green quantum dots surface-modified with a compound of Chemical Formula 4-1

(A-15) Green quantum dots surface-modified with the compound of Chemical Formula 4-2

(A-16) Green quantum dots surface-modified with the compound of Chemical Formula 4-3

(A-17) Green quantum dots surface-modified with the compound of Chemical Formula 4-4

(A-18) Green quantum dots without surface modification

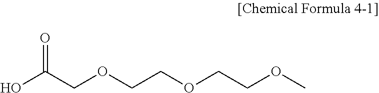

### (B) Polymerizable Compound

Compound represented by Chemical Formula 6-2 (M200, Miwon Chemical Co., Ltd.)

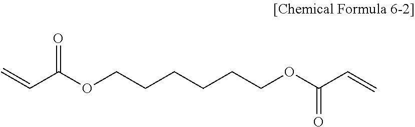 [SMILES: C=CC(=O)OCCCCCCOC(=O)C=C]

### (C) Photopolymerization Initiator

TPO-L (Polynetron Co.)

### (D) Light Diffusing Agent

Titanium dioxide dispersion (rutile type TiO₂, D50 (180 nm), solid content 50 wt %, Iridos Co., Ltd.)

### (E) Solvent

PGMEA (Sigma-Aldrich Corporation)

### (F) Binder Resin

Acrylic binder resin (SP-RY67-1, SHOWA DENKO)

### (G) Other Additives

Fluorine-based surfactant (F-554, DIC Co., Ltd.)

### Examples 1 to 10 and Comparative Examples 1 to 8

Each curable composition according to Examples 1 to 10 and Comparative Examples 1 to 8 is prepared with each composition shown in Tables 1 and 2 by using the following components.

TABLE 1
(unit: wt %)

| | | Ex. | Ex. | Ex. | Ex. | Ex. | Ex. | Ex. | Ex. | Ex. | Ex. |
|---|---|---|---|---|---|---|---|---|---|---|---|
| | | 1 | 2 | 3 | 4 | 5 | 6 | 7 | 8 | 9 | 10 |
| Quantum dots | (A-1) | 15 | — | — | — | — | — | — | — | — | — |
| | (A-2) | — | 15 | — | — | — | — | — | — | — | — |
| | (A-3) | — | — | 15 | — | — | — | — | — | — | — |
| | (A-4) | — | — | — | 15 | — | — | — | — | — | — |
| | (A-5) | — | — | — | — | 15 | — | — | — | — | — |
| | (A-6) | — | — | — | — | — | 15 | — | — | — | — |
| | (A-7) | — | — | — | — | — | — | 15 | — | — | — |
| | (A-8) | — | — | — | — | — | — | — | 15 | — | — |
| | (A-9) | — | — | — | — | — | — | — | — | 15 | — |
| | (A-10) | — | — | — | — | — | — | — | — | — | 15 |

| | | | | | | | | | | |
|---|---|---|---|---|---|---|---|---|---|---|
| Polymerizable compound | 4 | 4 | 4 | 4 | 4 | 4 | 4 | 4 | 4 | 4 |
| Photopolymerization initiator | 0.5 | 0.5 | 0.5 | 0.5 | 0.5 | 0.5 | 0.5 | 0.5 | 0.5 | 0.5 |
| Light diffusing agent | 3 | 3 | 3 | 3 | 3 | 3 | 3 | 3 | 3 | 3 |
| Solvent | 70 | 70 | 70 | 70 | 70 | 70 | 70 | 70 | 70 | 70 |
| Binder resin | 5 | 5 | 5 | 5 | 5 | 5 | 5 | 5 | 5 | 5 |
| Other additives | 2.5 | 2.5 | 2.5 | 2.5 | 2.5 | 2.5 | 2.5 | 2.5 | 2.5 | 2.5 |

TABLE 2
(unit: wt %)

| | | Comp. | Comp. | Comp. | Comp. | Comp. | Comp. | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 7 | Ex. 8 |
| Quantum dots | (A-11) | 15 | — | — | — | — | — | — | — |
| | (A-12) | — | 15 | — | — | — | — | — | — |
| | (A-13) | — | — | 15 | — | — | — | — | — |
| | (A-14) | — | — | — | 15 | — | — | — | — |
| | (A-15) | — | — | — | — | 15 | — | — | — |
| | (A-16) | — | — | — | — | — | 15 | — | — |
| | (A-17) | — | — | — | — | — | — | 15 | — |
| | (A-18) | — | — | — | — | — | — | — | 15 |

| | | | | | | | | |
|---|---|---|---|---|---|---|---|---|
| Polymerizable compound | 4 | 4 | 4 | 4 | 4 | 4 | 4 | 4 |
| Photopolymerization initiator | 0.5 | 0.5 | 0.5 | 0.5 | 0.5 | 0.5 | 0.5 | 0.5 |
| Light diffusing agent | 3 | 3 | 3 | 3 | 3 | 3 | 3 | 3 |
| Solvent | 70 | 70 | 70 | 70 | 70 | 70 | 70 | 70 |
| Binder resin | 5 | 5 | 5 | 5 | 5 | 5 | 5 | 5 |
| Other additives | 2.5 | 2.5 | 2.5 | 2.5 | 2.5 | 2.5 | 2.5 | 2.5 |

### Evaluation 1: Light Efficiency Evaluation of Curable Compositions

Each of the curable compositions according to Examples 1 to 10 and Comparative Examples 1 to 8 is evaluated with respect to light efficiency, and the results are shown in Table 3.

### (Evaluation Method of Light Efficiency)

Each of the curable compositions is coated, exposed, and baked to prepare a single layer specimen with a size of 2 cm×2 cm and then, measured with respect to light efficiency, pattern characteristics, and surface sensitivity under a blue 20,000 nit light source condition by using a self-manufactured blue LED planar light source lighting.

In addition, the single layer specimens are measured with respect to light efficiency by using an integrating sphere equipment (QE-2100, Otsuka Electronics Co., Ltd) and an in-line luminance meter (M7000, Mcscience Inc.).

Furthermore, the single layer specimens are examined with respect to pattern characteristics and surface sensitivity with naked eyes by using a scanning electron microscope (SEM), which are evaluated as Good or Inferior.

TABLE 3

| | Light | Pattern | Surface |
|---|---|---|---|
| | efficiency (%) | characteristics | sensitivity |
| Example 1 | 33.8 | Good | Good |
| Example 2 | 33.7 | Good | Good |
| Example 3 | 33.6 | Good | Good |
| Example 4 | 33.6 | Good | Good |
| Example 5 | 33.7 | Good | Good |
| Example 6 | 33.5 | Good | Good |
| Example 7 | 33.5 | Good | Good |
| Example 8 | 33.7 | Good | Good |
| Example 9 | 33.8 | Good | Good |
| Example 10 | 33.7 | Good | Good |
| Comparative Example 1 | 33.2 | Good | Good |
| Comparative Example 2 | 33.5 | Good | Good |
| Comparative Example 3 | 33.1 | Good | Good |
| Comparative Example 4 | 33.2 | Good | Good |
| Comparative Example 5 | 33.2 | Good | Good |
| Comparative Example 6 | 33.1 | Good | Good |
| Comparative Example 7 | 33.3 | Good | Good |
| Comparative Example 8 | 33.0 | Good | Good |

Referring to Table 3, the curable compositions of Examples 1 to 10 and Comparative Examples 1 to 8 all exhibit excellent light efficiency, pattern characteristics, and surface sensitivity.

### Evaluation 2: Evaluation of Light Resistance Reliability of Curable Composition Under High Light Resistance Conditions

Each of the curable compositions of Examples 1 to 10 and Comparative Examples 1 to 8 is evaluated with respect to light resistance reliability (a light retention rate) under high light resistance conditions (when allowed to stand at blue backlight of greater than or equal to 100,000 nit for greater than or equal to 500 hours), and the results are shown in Table 4.

TABLE 4

| | Light resistance reliability (%) |
|---|---|
| Example 1 | 67 |
| Example 2 | 65 |
| Example 3 | 62 |
| Example 4 | 63 |
| Example 5 | 64 |
| Example 6 | 57 |
| Example 7 | 58 |
| Example 8 | 63 |
| Example 9 | 64 |
| Example 10 | 62 |
| Comparative Example 1 | 45 |
| Comparative Example 2 | 48 |
| Comparative Example 3 | 42 |
| Comparative Example 4 | 41 |
| Comparative Example 5 | 44 |
| Comparative Example 6 | 45 |
| Comparative Example 7 | 43 |
| Comparative Example 8 | 31 |

Referring to Table 4, the curable compositions of Examples 1 to 10 exhibit very excellent light resistance reliability under the high light resistance conditions, compared with the curable compositions of Comparative Examples 1 to 8. In addition, the light resistance reliability turns out to be further improved by controlling the molar ratio of first and second functional groups.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

1. A curable composition, comprising:
(A) quantum dots including a first functional group represented by Chemical Formula 1 and a second functional group including a *—OC(═O) group at a terminal end, and
(B) a polymerizable compound: 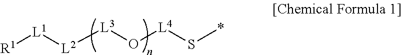
wherein, in Chemical Formula 1,
R¹ is a substituted or unsubstituted C1 to C20 alkyl group, a substituted or unsubstituted C3 to C20 cycloalkyl group, a substituted or unsubstituted C3 to C20 cycloalkenyl group, a substituted or unsubstituted C2 to C20 heterocycloalkyl group, a substituted or unsubstituted C6 to C20 aryl group, or a fused ring group thereof,
L¹ to L⁴ are each independently a single bond, an ether group (*—O—*), or a substituted or unsubstituted C1 to C20 alkylene group, and
n is an integer from 1 to 20.

2. The curable composition of claim 1, wherein
the second functional group is represented by Chemical Formula 2: 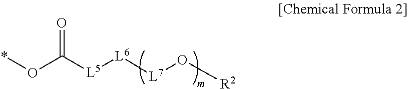
wherein, in Chemical Formula 2,
R² is a substituted or unsubstituted C1 to C20 alkyl group, a substituted or unsubstituted C3 to C20 cycloalkyl group, a substituted or unsubstituted C2 to C20 heterocycloalkyl group, a substituted or unsubstituted C6 to C20 aryl group, or *—C(═O)R³, wherein R³ is a C1 to C10 alkyl group or 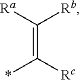
wherein R^{a} to R^{c} are each independently a hydrogen atom or a C1 to C10 alkyl group,
L⁵ to L⁷ are each independently a single bond, an ether group (*—O—*), an ester group (*—C(═O)O—* or *—OC(═O)—*), or a substituted or unsubstituted C1 to C20 alkylene group, and
m is an integer of 1 to 20.

3. The curable composition of claim 1, wherein
the first functional group and second functional group are included in a molar ratio of 1:0.5 to 1:1.5.

4. The curable composition of claim 1, wherein
the first functional group represented by at least one selected from Chemical Formula 1-1 to Chemical Formula 1-3:

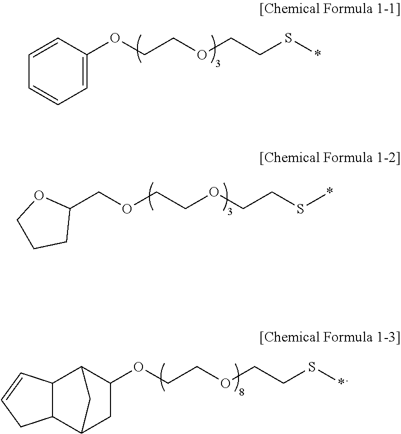

5. The curable composition of claim 1, wherein
the second functional group is represented by at least one selected from Chemical Formula 2-1 to Chemical Formula 2-4:

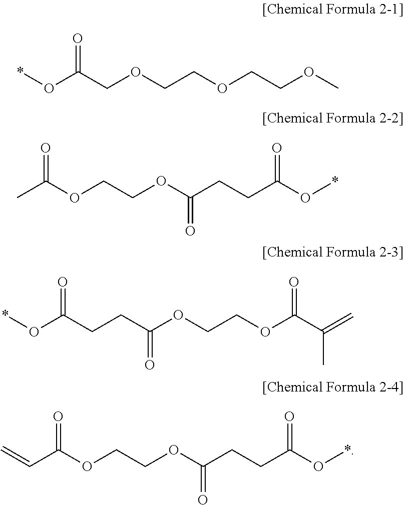

6. The curable composition of claim 1, wherein
the first functional group is derived from a compound represented by Chemical Formula 3: 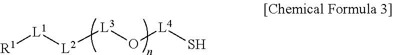
wherein, in Chemical Formula 3,
R¹ is a substituted or unsubstituted C1 to C20 alkyl group, a substituted or unsubstituted C3 to C20 cycloalkyl group, a substituted or unsubstituted C3 to C20 cycloalkenyl group, a substituted or unsubstituted C2 to C20 heterocycloalkyl group, a substituted or unsubstituted C6 to C20 aryl group, or a fused ring group thereof,
L¹ to L⁴ are each independently a single bond, an ether group (*—O—*), or a substituted or unsubstituted C1 to C20 alkylene group, and
n is an integer from 1 to 20.

7. The curable composition of claim 6, wherein
the compound represented by Chemical Formula 3 is represented by at least one selected from Chemical Formula 3-1 to Chemical Formula 3-3:

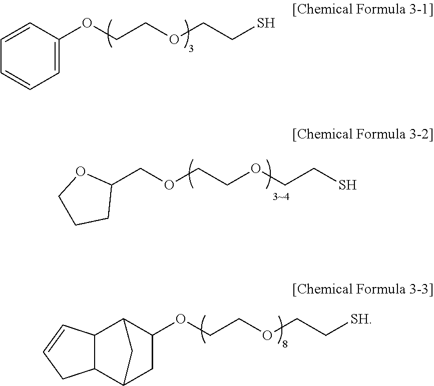

8. The curable composition of claim 1, wherein
the second functional group is derived from a compound represented by Chemical Formula 4: 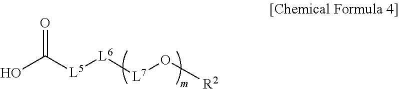
wherein, in Chemical Formula 4,
R² is a substituted or unsubstituted C1 to C20 alkyl group, a substituted or unsubstituted C3 to C20 cycloalkyl group, a substituted or unsubstituted C2 to C20 heterocycloalkyl group, a substituted or unsubstituted C6 to C20 aryl group, or *—C(═O)R³, wherein R³ is a C1 to C10 alkyl group or 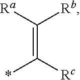
wherein R^{a} to R^{c} are each independently a hydrogen atom or a C1 to C10 alkyl group,
L⁵ to L⁷ are each independently a single bond, an ether group (*—O—*), an ester group (*—C(═O)O—* or *—OC(═O)—*), or a substituted or unsubstituted C1 to C20 alkylene group, and
m is an integer of 1 to 20.

9. The curable composition of claim 8, wherein
the compound represented by Chemical Formula 4 is represented by at least one selected from Chemical Formula 4-1 to Chemical Formula 4-4:

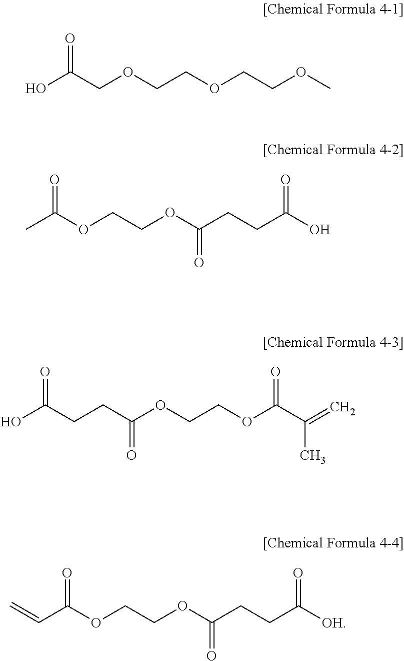

10. The curable composition of claim 1, wherein
the curable composition further includes a polymerization initiator, a binder resin, a light diffusing agent, a solvent, or a combination thereof.

11. The curable composition of claim 10, wherein
the light diffusing agent includes barium sulfate, calcium carbonate, titanium dioxide, zirconia, or a combination thereof.

12. The curable composition of claim 10, wherein
the curable composition further includes malonic acid; 3-amino-1,2-propanediol; a polymerization inhibitor; a silane-based coupling agent; a leveling agent; a fluorine-based surfactant; or a combination thereof.

13. The curable composition of claim 10, wherein
the curable composition includes, based on a total weight of the curable composition,
1 wt % to 40 wt % of the quantum dots;
1 wt % to 20 wt % of the polymerizable compound;
0.1 wt % to 5 wt % of the polymerization initiator;
1 wt % to 30 wt % of the binder resin;
1 wt % to 20 wt % of the light diffusing agent; and
40 wt % to 80 wt % of the solvent.

14. A cured layer manufactured using the curable composition of claim 1.

15. A display device comprising the cured layer of claim 14.
